(19) United States
(12) Patent Application Publication
(10) Pub. No.: US 2018/0208343 A1
(43) Pub. Date: Jul. 26, 2018

(54) Method and System for Wrapping and Preparing Facemasks for Packaging in a Manufacturing Line

(71) Applicant: Avent, Inc., Alpharetta, GA (US)

(72) Inventors: Joseph P. Weber, Suwanee, GA (US); Ajay Y. Houde, Johns Creek, GA (US); David L. Harrington, Cumming, GA (US); Mark T. Pamperin, Cumming, GA (US); Nathan C. Harris, Canton, GA (US)

(73) Assignee: Avent, Inc., Alpharetta, GA (US)

(21) Appl. No.: 15/502,635

(22) PCT Filed: Oct. 16, 2015
(86) PCT No.: PCT/US2015/055876

§ 371 Date: Feb. 8, 2017

(51) Int. Cl. B65B 35/24; B65B 9/067; B65B 25/20; B65B 35/18; B65B 51/30; B65B 61/06; B65B 65/00; B26F 1/38; B26D 7/32

(52) U.S. Cl. CPC B65B 35/24; B65B 9/067; B65B 25/20; B65B 35/18; B26D 7/32; B65B 61/06; B65B 65/003; B26F 1/384; B65B 51/30

(57) ABSTRACT

An automated method and system for preparing facemask for subsequent stacking and packaging in a facemask production line include conveying individual facemasks in an alternating and offset nesting pattern on a first conveyor at a first conveying speed. The facemasks are transferred to a second conveyor having a second conveying speed that is greater than the first conveying speed so that an increased gap is generated between adjacent facemasks. The aligned facemasks are wrapped at an automated in-line wrapping station wherein a continuous wrapping material is bonded around each individual facemask. At an in-line cutting station, the bonded wrapping material is cut between each adjacent facemask.

### FIELD OF THE INVENTION

The present invention relates generally to the field of protective facemasks, and more specifically to a method for wrapping and preparing the facemask for further packaging in the manufacturing line of such facemasks.

### FAMILY OF RELATED APPLICATIONS

The present application is related by subject matter to the following concurrently filed PCT applications (all of which designate the US):

a. Attorney Docket No.: 64973915PC01 (HAY-3034A-PCT); International Application No.: PCT/US2015/055858; entitled “Method and System for Splicing Nose Wire in a Facemask Manufacturing Process”.

b. Attorney Docket No.: 64973915PC02 (HAY-3034B-PCT); International Application No.: PCT/US2015/055861; entitled “Method and System for Splicing Nose Wire in a Facemask Manufacturing Process”.

c. Attorney Docket No.: 64973915PC03 (HAY-3034C-PCT); International Application No.: PCT/US2015/055863; entitled “Method and System for Introducing a Reserve Nose Wire in a Facemask Production Line”.

d. Attorney Docket No.: 64973906PC01 (HAY-3035A-PCT); International Application No.: PCT/US2015/055865; entitled “Method and System for Cutting and Placing Nose Wires in a Facemask Manufacturing Process”.

e. Attorney Docket No.: 64973906PC02 (HAY-3035B-PCT); International Application No.: PCT/US2015/055867; entitled “Method and System for Placing Nose Wires in a Facemask Manufacturing Process”.

f. Attorney Docket No.: 64973906PC03 (HAY-3035C-PCT); International Application No.: PCT/US2015/055871; entitled “Method and System for Placing Nose Wires in a Facemask Manufacturing Process”.

g. Attorney Docket No.: 64973906PC04 (HAY-3035D-PCT); International Application No.: PCT/US2015/055872; entitled “Method and System for Placing Nose Wires in a Facemask Manufacturing Process”.

h. Attorney Docket No.: 64973896PC02 (HAY-3036B-PCT); International Application No.: PCT/US2015/055878; entitled “Method and System for Automated Stacking and Loading Wrapped Facemasks into a Carton in a Facemask Manufacturing Line”.

i. Attorney Docket No.: 64973896PC03 (HAY-3036C-PCT); International Application No.: PCT/US2015/055882; entitled “Method and System for Automated Stacking and Loading of Wrapped Facemasks into a Carton in a Facemask Manufacturing Line”.

The above cited applications are incorporated herein by reference for all purposes. Any combination of the features and aspects of the subject matter described in the cited applications may be combined with embodiments of the present application to yield still further embodiments of the present invention.

### BACKGROUND OF THE INVENTION

Various configurations of disposable filtering facemasks or respirators are known and may be referred to by various names, including “facemasks”, “respirators”, “filtering face respirators”, and so forth. For purposes of this disclosure, such devices are referred to generically as “facemasks.”

The ability to supply aid workers, rescue personnel, and the general populace with protective facemasks during times of natural disasters or other catastrophic events is crucial. For example, in the event of a pandemic, the use of facemasks that offer filtered breathing is a key aspect of the response and recovery to such event. For this reason, governments and other municipalities generally maintain a ready stockpile of the facemasks for immediate emergency use. However, the facemasks have a defined shelf life, and the stockpile must be continuously monitored for expiration and replenishing. This is an extremely expensive undertaking.

Recently, investigation has been initiated into whether or not it would be feasible to mass produce facemasks on an “as needed” basis during pandemics or other disasters instead of relying on stockpiles. For example, in 2013, the Biomedical Advanced Research and Development Authority (BARDA) within the Office of the Assistant Secretary for Preparedness and Response in the U.S. Department of Health and Human Services estimated that up to 100 million facemasks would be needed during a pandemic situation in the U.S., and proposed research into whether this demand could be met by mass production of from 1.5 to 2 million facemasks per day to avoid stockpiling. This translates to about 1,500 masks/minute. Current facemask production lines are capable of producing only about 100 masks/minute due to technology and equipment restraints, which falls far short of the estimated goal. Accordingly, advancements in the manufacturing and production processes will be needed if the goal of “on demand” facemasks during a pandemic is to become a reality.

In conventional facemask production lines, once the facemasks have been cut and wrapped, manual labor is necessary to align, stack, and place the masks in a carton. These manual steps are a significant impediment to mass production of the facemasks at the throughputs mentioned above.

The present invention addresses this need and provides a method and related system for high speed aligning, wrapping, and cutting of the facemasks into individual products that are capable of being conveyed for further high speed stacking and packaging.

### SUMMARY OF THE INVENTION

Objects and advantages of the invention will be set forth in the following description, or may be obvious from the description, or may be learned through practice of the invention.

In accordance with aspects of the invention, an automated method is provided for preparing facemask for subsequent stacking and packaging in a facemask production line. Individual facemasks that have been assembled in the production line are conveyed in an alternating and offset nesting pattern on a first conveyor at a first conveying speed. The facemasks are “offset” in a transvers direction relative to the conveying direction such that their respective ends (the closed and open ends of the masks) are not aligned. A gap or spacing between adjacent facemasks is increased by transferring the facemasks to a second conveyor having a second conveying speed that is greater than the first conveying speed. In this “gapped” state, the facemasks are conveyed to an automated in-line wrapping station wherein a continuous wrapping material is bonded around each individual facemask. The wrapped (but still connected together by the wrapping material) facemasks are then conveyed to an in-line cutting station where the bonded wrapping material is cut between adjacent facemasks to produce individually wrapped and separated facemasks that may then be conveyed to a downstream stacking and packaging process.

In a particular embodiment, the facemasks are deposited directly from the first conveyer onto the second conveyor without an intervening device or process. In an alternative embodiment, the facemasks are transferred from the first conveyor to second conveyor by an intermediate conveyor or placement device that spans between the first and second conveyors. This intermediate device may be, for example, a vacuum conveyor or vacuum puck placer.

In a certain embodiment, the method further includes, prior to the wrapping step, aligning the facemasks along a common conveying axis by removing the offset between adjacent facemasks as the facemasks are conveyed along the production line. After this, the facemasks have aligned ends prior to entering the wrapping station. With this method embodiment, at the cutting station, a cut line is made between adjacent facemask that is essentially perpendicular to the common conveying axis to separate the wrapped facemasks into individual rectangular articles. Thus, a single cut line can be made at the cutting station to separate the wrapped facemasks.

In the embodiment wherein the facemasks remain offset through the wrapping station, the gap between adjacent facemasks need not be as great. At the cutting station, alternating (oppositely-angled) non-perpendicular cut lines are made between adjacent facemasks relative to a conveying direction of the facemasks through the cutting station. Additional cut lines may also be made at the cutting station that are parallel to the conveying direction and adjacent to an end of the facemasks. This embodiment may be useful for facemasks having a trapezoidal shape (e.g., “duckbill” facemasks), wherein the different cut lines made at the cutting station produce individual wrapped trapezoidal articles.

The present invention also encompasses various system embodiments for automated preparation of facemasks for subsequent stacking and packaging in a facemask production line in accordance with the present methods, as described and supported herein.

Other features and aspects of the present invention are discussed in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a perspective view of a conventional respiratory facemask worn by a user, the facemask incorporating a nose wire to conform the facemask to the user's face;

FIG. 2 is a top view of the conventional facemask of FIG. 1 is a folded state;

FIG. 3 is a schematic representation of facemask production line in which embodiments of the present method may be incorporated;

FIG. 4 is a schematic representation of aspects in accordance with the present invention for spacing, wrapping, and cutting facemasks in an in-line production line; and

FIG. 5 is a schematic representation of other aspects in accordance with the present invention for spacing, wrapping, and cutting facemasks in an in-line production line.

### DETAILED DESCRIPTION OF REPRESENTATIVE EMBODIMENTS

Reference now will be made in detail to various embodiments of the invention, one or more examples of which are set forth below. Each example is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention covers such modifications and variations as come within the scope of the appended claims and their equivalents.

As mentioned, the present methods relate to methods for spacing, aligning, wrapping and cutting of facemask in an automated production line. The facemasks may then be conveyed to a stacking and packaging process. The current methods will reduce the time spent on these processes as compared to current production lines, and thus contribute to achieving the production throughputs necessary for on-demand facemasks during extreme situations (e.g., a pandemic or natural disaster). It should be appreciated that that the upstream production steps for forming the individual facemasks are not limiting aspects of the invention and, thus, will not be explained in great detail herein.

Also, the present disclosure refers to or implies conveyance or transport of certain components of the facemasks through the production line. It should be readily appreciated that any manner and combination of article conveyors (e.g., rotary and linear conveyors), article placers (e.g. vacuum puck placers), and transfer devices are well known in the article conveying industry and can be used for the purposes described herein. It is not necessary for an understanding and appreciation of the present methods to provide a detailed explanation of these well-known devices and system.

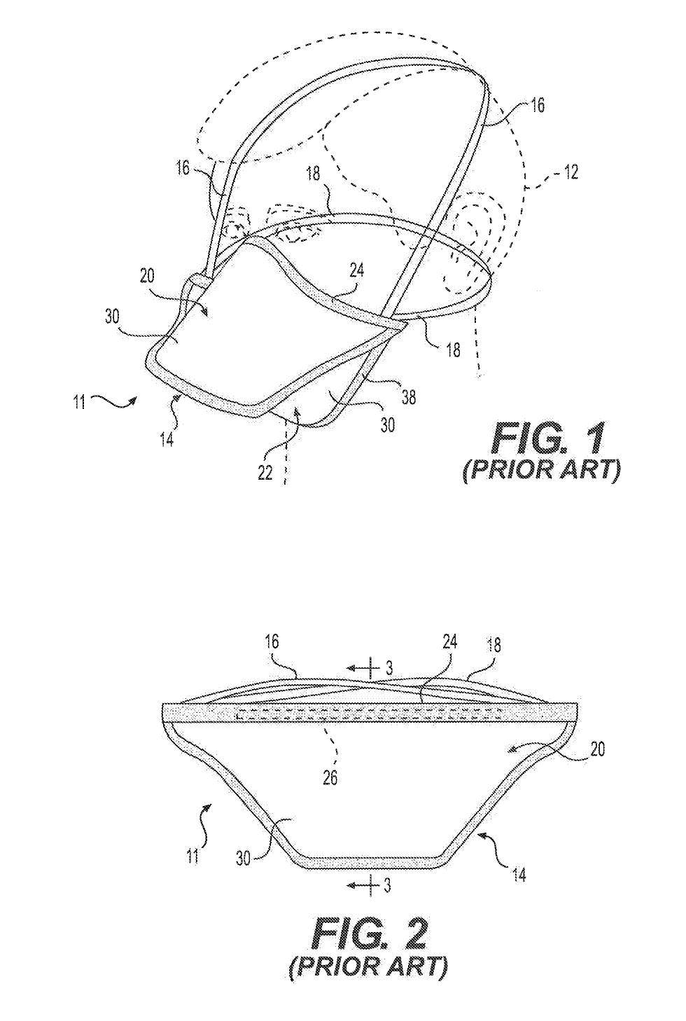

Various styles and configurations of facemasks, including generally trapezoidal cone masks and flat pleated facemasks are well-known, and the present methods may have utility in the production lines for these conventional masks. For illustrative purposes only, aspects of the present method are described herein with reference to a particular type of trapezoidal respirator facemask often referred to in the art as a “duckbill” mask, as illustrated in FIG. 1.

Referring to FIGS. 1-3, a representative facemask 11 (e.g., a duckbill facemask) is illustrated on the face of wearer 12. The mask 11 includes filter body 14 that is secured to the wearer 12 by means of resilient and elastic straps or securing members 16 and 18. The filter body 14 includes an upper portion 20 and a lower portion 22, both of which have complimentary trapezoidal shapes and are preferably bonded together such as by heat and/or ultrasonic sealing along three sides. Bonding in this manner adds important structural integrity to mask 11.

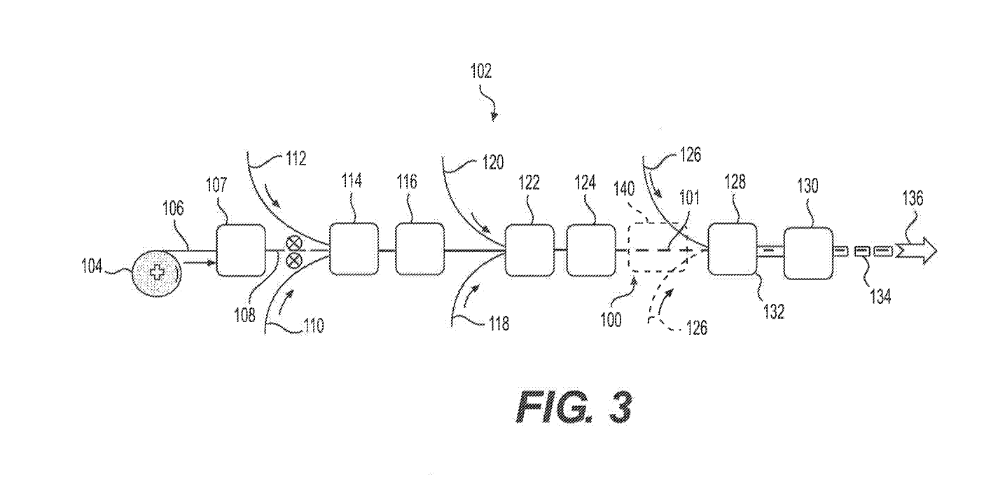

The fourth side of the mask 11 is open and includes a top edge 24 and a bottom edge 38, which cooperate with each other to define the periphery of the mask 11 that contacts the wearer's face. The top edge 24 is arranged to receive an elongated malleable member 26 (FIGS. 2 and 3) in the form of a flat metal ribbon or wire (referred to herein as a “nose wire”). The nose wire 26 is provided so that top edge 24 of mask 11 can be configured to closely fit the contours of the nose and cheeks of wearer 12. The nose wire 26 is typically constructed from an aluminum strip with a rectangular cross-section. With the exception of having the nose wire 26 located along top edge 24 of the upper portion 20 of the mask 11, the upper and lower portions 20 and 22 may be identical.

As shown in FIG. 1, the mask 11 has the general shape of a cup or cone when placed on the face of wearer 12 and thus provides “off-the-face” benefits of a molded-cone style mask while still being easy for wearer 12 to carry mask 11 in a pocket prior to use. “Off-the-face” style masks provide a larger breathing chamber as compared to soft, pleated masks which contact a substantial portion of the wearer's face. Therefore, “off-the-face” masks permit cooler and easier breathing.

Blow-by associated with normal breathing of wearer 12 is substantially eliminated by properly selecting the dimension and location of the nose wire 26 with respect to top edge of 24. The nose wire 26 is preferably positioned in the center of top edge 24 and has a length in the range of fifty percent (50%) to seventy percent (70%) of the total length of the top edge 24.

As illustrated in cross-sectional view of FIG. 3, the upper and lower portions 20 and 22 may include multiple layers and each have an outer mask layer 30 and inner mask layer 32. Located between outer and inner mask layers 30, 32 are one or more intermediate filtration layers 34. These layers are typically constructed from a melt-blown polypropylene, extruded polycarbonate, melt-blown polyester, or a melt-blown urethane.

The top edge 24 of the mask 11 is faced with an edge binder 36 that extends across the open end of mask 11 and covers the nose wire 26. Similarly, the bottom edge 38 is encompassed by an edge binder 40. Edge binders 36 and 40 are folded over and bonded to the respective edges 24, 30 after placement of the nose wire 26 along the top edge 24. The edge binders 36, 40 may be constructed from a spun-laced polyester material.

FIG. 3 depicts portions of a generic production line 102 for automated, in-line production of individual facemasks. It should be appreciated that the various processes, equipment, controls, etc., can vary greatly between different production lines 102, and that FIG. 3 is presented for illustrative purposes only. The methods described herein will have utility in many different types of production lines 102.

FIG. 3 represents a production line 102 wherein nose wires are incorporated into an edge of the facemasks. A running nose wire 106 is supplied in continuous strip form from a source, such as a driven spool or roll 104, to a cutting station 107 wherein the wire 106 is cut into individual nose wires 108 having a defined length. Suitable cutting stations 108 are known and used in conventional production lines.

The nose wires 108 are conveyed onto a carrier web 110, which, referring to FIG. 2, may be the continuous multi-layer web that defines the upper body portion 20 of the finished face mask 11. The individual nose wires 108 are deposited along the edge of the carrier web 110 corresponding to the top edge 24 of the facemask 11 in FIG. 2.

After placement of the individual nose wires 108 in position on the carrier web 110, a binder web 112 is introduced to the production line 102 along both edges of the carrier web 110 (only one binder web 112 is depicted in FIG. 3.). The combination of carrier web 110, nose wire 108, and binder webs 112 pass through a folding station 114 wherein the binder webs 112 are folded around the respective running edges of the carrier web 110. The components then pass through a bonding station 116 wherein the binder webs 112 are thermally bonded to the carrier web 110, thereby producing the edge configurations 24, 38 depicted in FIGS. 1 and 2. The nose wire 108 is essentially encapsulated along the top edge 24 by the binder web 112.

From the bonding station 116, the continuous combination of carrier web 110 with nose wires 108 encapsulated in the binder 112 is conveyed to another bonding station 122. At this station, an additional web 118 is introduced that corresponds to the lower panel portion 22 of the face mask 11 depicted in FIGS. 1 and 2. This web 118 may already have the binder web applied to the edge thereof from an upstream process. Continuous elastomeric straps 120 are also introduced and are laid between the edges of the web 118 and web 110 corresponding to the edges 24, 28 in FIG. 1. The materials are bonded together in a bond pattern that corresponds to the trapezoidal shape of the facemask 11 with a closed end and an open end at the edges 24, 28.

The bonded webs 110 and 118 (with nose wires and straps) are conveyed to a cutting station 124 wherein the individual facemasks 101 are cut out from the webs along the bond lines.

The facemasks 101 are conveyed through a gapping/aligning station 140 that spaces and aligns the continuous stream of individual facemasks 101 for downstream wrapping. This gapping/aligning station 140 is described in greater detail below.

The facemasks 101 are then conveyed to a bonding station 128 wherein wrapping materials 126 (e.g. a poly material) are introduced and are folded (if necessary) and bonded around the individual facemasks 101. A single web of the wrapping material 126 may be folded around the facemasks and sealed along a continuous longitudinal bond line or, in an alternate embodiment depicted by the dashed line in FIG. 3, an additional web of the wrapping material 126 may be introduced to the bonding station, wherein the facemasks are sandwiched between the two webs 126. The webs 126 are then sealed along continuous longitudinal bond lines along their mating edges.

A continuous stream of wrapped facemasks 132 emerge from the bonding station 128 and are conveyed to a cutting station 130 wherein cuts are made in the bonded wrapping material in a desired pattern to produce individual wrapped facemasks 134. These masks 134 are conveyed to downstream processing stations 136 for further processing, including stacking and packaging.

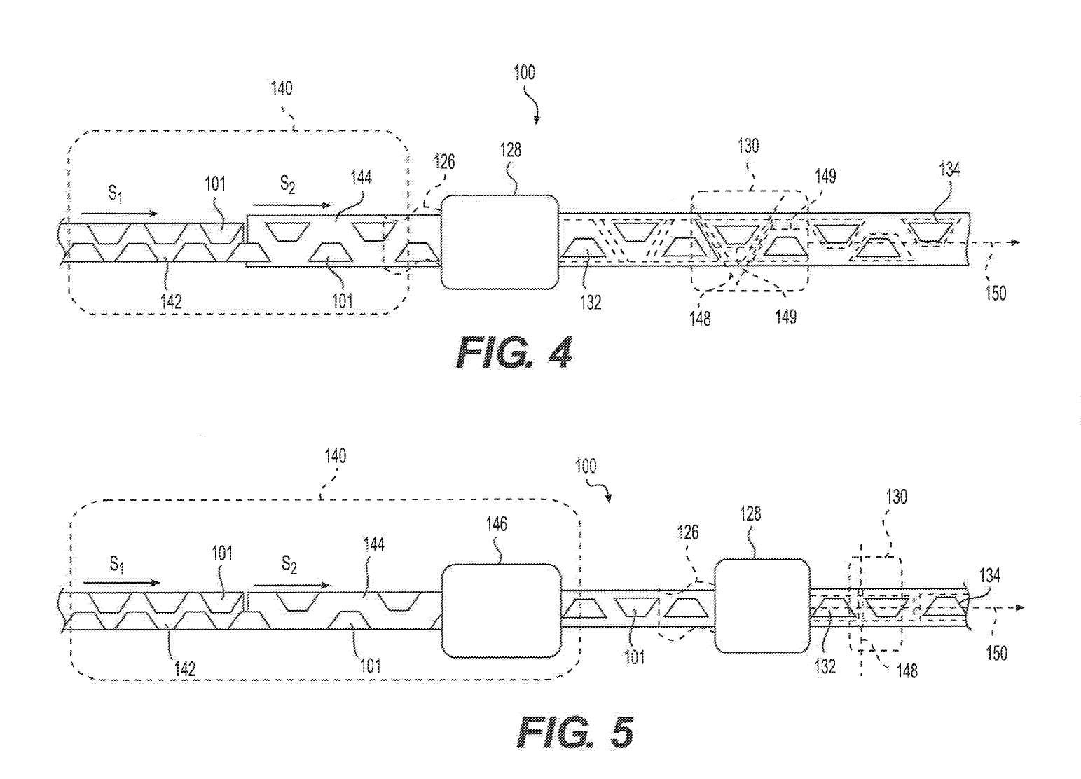

With further reference to FIGS. 4 and 5, embodiments of a method 100 are depicted that relate to the gapping/aligning process at station 140, as well as subsequent wrapping at station 128 and cutting at station 130.

Referring to the embodiment of FIG. 4, the individual facemasks 101 assembled in the production line 102 are conveyed in an alternating and offset nesting pattern on a first conveyor 142 at a first conveying speed S₁. As can be appreciated from the figure, the facemasks 101 are “offset” in a transvers direction relative to the conveying direction such that their respective alternating ends (the closed and open ends of the masks) are not aligned. This offset generally occurs as a result of the cut pattern at station 124 wherein the web material between adjacent masks is cut out and discarded. An initial gap (relative to the conveying direction) is also present between adjacent facemasks 101 on the first conveyor 142.

The method 100 includes increasing the gap or spacing between the adjacent facemasks 101 by transferring the facemasks 101 to a second conveyor 144 having a second conveying speed S_{2 that} is greater than the first conveying speed S₁. The speed differential between the conveyors 142, 144 causes the facemasks 101 to accelerate as they are transferred to the second conveyor 144, thereby increasing the gap or spacing between the facemasks 101 on the second conveyor 144 as compared to the first conveyor 142.

In a particular embodiment depicted in FIGS. 4 and 5, the facemasks are deposited directly from the first conveyer 142 onto the second conveyor 144 without an intervening device or process. However, in alternate embodiments, an intermediate device may be used to pick the facemasks 101 off of the first conveyor 142 and place them onto the second conveyor 144. This intermediate device may be, for example, a vacuum conveyor, a vacuum puck placer, or other conventional article placer.

FIG. 4 depicts an embodiment wherein the facemasks 101 are conveyed in their gapped and offset state on the second conveyor 144 to an automated in-line wrapping station that includes a bonder 128. Conventional wrapping material 126 (e.g. a poly material) is also conveyed to the bonder 128, and a continuous bond is formed in the layers of wrapping material 126 around each facemask, as indicated by the dashed lines in the wrapper material immediately downstream of the bonder 128. The wrapped (but still connected together by the wrapping material) facemasks 132 are then conveyed to an in-line cutting station 130 wherein cuts are made in the bonded wrapping material generally along the bond lines produce individually wrapped and separated facemasks 134 that are then be conveyed to a downstream stacking and packaging process.

The cutting station 130 may utilize any sort of cutting apparatus, such as a cutter roll that has blades oriented to produce longitudinal (in the conveying direction 150) cut lines 149 and transverse cut lines 148. The longitudinal cut lines may be parallel to the conveying direction 150 and adjacent to an end of the facemasks 101. In the embodiment wherein the facemasks 101 are trapezoidal and nested as depicted in FIG. 4, the transverse cut lines 148 may alternate in direction (e.g., opposite and equal angles) between adjacent facemasks 101 at non-perpendicular angles relative to the conveying direction 150. This embodiment may be useful for “duckbill” facemasks, wherein the different cut lines 148, 149 produce individual wrapped trapezoidal articles 134.

In an alternate embodiment, the bonding and cutting processes may be merged into a single station. For example the bonding station may use a laser bonder that not only seals the wrapping material 126, but also cuts the wrapping material 126 along the bond lines.

Referring to FIG. 5, in a certain embodiment, the method 100 may further include, prior to the wrapping step, aligning the facemasks at an alignment station 146 along a common conveying axis by removing the offset between adjacent facemasks 101 as the facemasks are conveyed along the production line. The facemasks may be aligned at the station 146 by guides positioned along the conveying path, or by an active device, such as a vacuum puck placer that picks up and repositions the facemasks 101. After this alignment, the facemasks 101 have aligned ends prior to entering the wrapping station 128, as depicted in FIG. 5. With this embodiment, at the cutting station 128, a cut line 148 is made between adjacent facemask that is essentially perpendicular to the common conveying axis 150 to separate the wrapped facemasks 132 into individual rectangular articles 134. Thus, a single cut line 148 can be made at the cutting station 130 to separate the wrapped facemasks 132.

In the embodiment of FIG. 4 wherein the facemasks 101 remain offset through the wrapping station 128, the gap between adjacent facemasks need not be as great as compared to the gap in FIG. 5.

As mentioned, the present invention also encompasses various system embodiments for preparing facemask for subsequent stacking and packaging in a facemask production line in accordance with the present methods. Aspects of such systems are illustrated in the figures, and described and supported above.

The material particularly shown and described above is not meant to be limiting, but instead serves to show and teach various exemplary implementations of the present subject matter. As set forth in the attached claims, the scope of the present invention includes both combinations and sub-combinations of various features discussed herein, along with such variations and modifications as would occur to a person of skill in the art.

1. An automated method for preparing facemasks for subsequent stacking and packaging in a facemask production line, comprising:
cutting individual facemasks in a cut pattern from a web at a cutting station, the cut pattern producing an alternating and offset nesting pattern;
conveying the individual facemasks in the alternating and offset nesting pattern on a first conveyor at a first conveying speed with an initial gap between adjacent facemasks;
transferring the facemasks from the first conveyor onto a top surface of a second conveyor having a second conveying speed that is greater than the first conveying speed so that an increased gap is generated between adjacent facemasks;
conveying the facemasks at their offset and gapped state laying on the second conveyor to an automated in-line wrapping station;
wrapping the facemasks at an automated in-line wrapping station wherein a continuous wrapping material is bonded around each individual facemask; and
at an in-line cutting station, cutting the bonded wrapping material between each adjacent facemask.

2. The method as in claim 1, wherein the facemasks are deposited directly from the first conveyer onto the second conveyor.

3. The method as in claim 1, wherein the facemasks are transferred from the first conveyor to the second conveyor by an intermediate device that functionally spans between the first and second conveyors.

4. The method as in claim 3, wherein the intermediate device is a vacuum conveyor or a vacuum puck placer.

5. The method as in claim 1, further comprising, prior to the wrapping step, aligning the facemasks along a common conveying axis by removing the offset between adjacent facemasks as the facemasks are conveyed along the production line.

6. The method as in claim 5, wherein, at the cutting station, a cut line is made between adjacent facemask that is perpendicular to the common conveying axis to separate the wrapped facemasks into individual rectangular articles.

7. The method as in claim 6, wherein the facemasks have a trapezoidal shape and are wrapped in a rectangular wrapper.

8. The method as in claim 1, wherein, at the cutting station, alternating non-perpendicular cut line is made between adjacent facemasks relative to a conveying direction of the facemasks through the cutting station.

9. The method as in claim 8, further comprising making an additional cut line at the cutting station that is parallel to the conveying direction and adjacent to an end of the facemasks.

10. The method as in claim 9, wherein the facemasks have a trapezoidal shape, and the cuts lines at the cutting station result in individual wrapped trapezoidal articles.

11. A system for preparing facemask for subsequent stacking and packaging in a facemask production line, wherein the system is specifically configured to practice the method of claim 1.
